(19) United States
(12) Patent Application Publication
(10) Pub. No.: US 2023/0364701 A1
(43) Pub. Date: Nov. 16, 2023

(54) SINGLE-SPOT WELDING DEVICE

(71) Applicant: EVG ENTWICKLUNGS- U. VERWERTUNGS-GESELLSCHAFT M.B.H., Raaba (AT)

(72) Inventor: Andreas BACI, Graz (AT)

(21) Appl. No.: 18/245,570

(22) PCT Filed: Sep. 14, 2021
(86) PCT No.: PCT/IB2021/058348

§ 371 Date: Mar. 16, 2023

(30) Foreign Application Priority Data
Sep. 17, 2020 (AT) A50794/2020

(51) Int. Cl. B23K 11/11; B23K 11/00; B23K 11/31

(52) U.S. Cl. CPC B23K 11/11; B23K 11/008; B23K 11/311; B23K 2101/22

(57) ABSTRACT

A single-spot welding device having a welding ram, the welding ram having a welding electrode, wherein the welding ram is movable cyclically out of a starting position to a welding material, and an electric drive is provided, by means of which the welding ram can be moved to the welding material and by means of which the force can be applied to the welding material. The method for carrying out welding comprises the following steps: moving a welding ram of a single-spot welding device out of a starting position by means of an electric drive, pressing the welding ram during the welding by means of an electric drive, and moving the welding ram back into the starting position.

### FIELD

The invention relates to a single-spot welding device with a welding plunger, wherein the welding plunger has a welding electrode and wherein the welding plunger can be moved cyclically from a starting position to a welding material. The invention also relates to a method for performing a welding and to a wire mesh.

### BACKGROUND

Single-spot welding devices are used, among other things, in automatic wire mesh welding machines in which a large number of parallel-operating devices cyclically weld automatically fed transverse wires and longitudinal wires. In the prior art, force is applied to the welding spot by means of a welding electrode to carry out a resistance welding process either mechanically (e.g. by coil springs), pneumatically or hydraulically. These methods are difficult to adjust in terms of the desired force magnitude and, in hydraulic applications, cause oil contamination of the welding equipment. Efforts are therefore being made to develop an electrical force application system that avoids these disadvantages and provides the setting values required for the necessary pressure (force per area) in an exactly reproducible manner. Up to now, however, spot welds of concrete reinforcement elements or even individual spot welds have been produced exclusively on equipment with the disadvantageous pressure applications described.

Since automated welding systems are machines that operate at a very high number of welding cycles, in previous force application systems the force application elements are set in motion in a time-controlled manner. These are referred to as controlled systems, in which the position of the force element and consequently also the exact application point on the material to be welded is not precisely known.

High-performance welding machines consist of several power application elements, the synchronization of which is very difficult to achieve with pneumatic and hydraulic components. In practice, it is necessary to wait for the slowest element, which leads to a limitation of the machine speed.

DE 102014004102 A1, CN 105127574 A describe electrically driven welding tongs and welding electrodes in car body construction. Here, thin sheets are welded in short welding times for each point with known contact points. The controls of this prior art assume an optimizable welding force system in which measured values from strain gauges or piezo elements are used. These systems are not transferable to welding wires of varying diameter, quality and ribbed surfaces.

### SUMMARY

The object of the invention is to overcome the disadvantages of the prior art and to achieve a high number of welding spots to be produced simultaneously in a short cycle. The quality of the welding spots of a mesh mat should be raised and equalized. The result is to be inexpensive to achieve and easy to maintain.

The single-spot welding device according to the invention achieves this object by providing an electric drive by which the welding plunger can be moved to the welding spot and by which a force can be applied onto the welding spot.

In a further embodiment, the electric drive is a linear motor.

In an alternative, the electric drive is a servo motor connected to the welding plunger by means of a spindle or a rack to perform the movement of the welding plunger.

In another alternative, the single-spot welding device has a position feedback means to cyclically move the welding plunger to an initial and nominal position.

In addition, the electric drive can alternatively be a servomotor that is connected to the welding plunger by means of a cam, wherein the welding plunger is designed as a spring plunger.

In a further embodiment, a mechanical damping element is provided between the electric drive and the current-carrying part of the single-spot welding device. The damping element can be a spring.

Furthermore, in one alternative, the ratio of external mass to motor mass can be less than 1.

The method for performing a weld according to the invention comprises the steps:
approaching a welding plunger of a single-spot welding device from a starting position to a welding material by means of an electric drive,
pressing the welding plunger before and/or during welding onto the welding material by means of an electric drive and
returning the welding plunger to the starting position.

In one embodiment of the method, the following step takes place:
increasing the welding force during welding by applying force to the welding plunger using the electric drive.

Alternatively, the step of approaching the welding plunger is performed in the sub-steps:
approaching the welding plunger in the direction of the welding spot at a maximum speed,
approaching an end position of the welding plunger at reduced speed and
stopping the approach to the end position before the end position is reached.

In another embodiment, an electrical control system is provided to control the electrical drive and monitor the positions of the welding plunger.

Alternatively, the following two steps are additionally provided:
comparing the nominal and actual values of the position of the welding plunger and
calculating a wear from the nominal and actual values.

Also, in an embodiment, the following step may be included: calculating wear of at least one of the welding plungers from reading the torque characteristic, or the welding force characteristic.

In a further embodiment, the quality of weld nodes is calculated from the movement data of the welding plungers in comparison to pre-calculated values.

In order to eliminate the disadvantages of the prior art according to the invention and to be able to comply with further developments required due to market demands in terms of energy efficiency and quality assurance, the use of an electric welding force application brings surprising advantages and solves the existing problems.

The internal development of the electrical components to be used is already so far advanced that the required dynamics and also the costs to be expected can justify their use.

### BRIEF DESCRIPTION OF THE DRAWINGS

The invention is explained in more detail below with reference to an example of an embodiment shown in the drawings. In particular:

FIG. 1 shows a perspective view of a group of six single-spot welding devices;

FIG. 2 shows a side view of the single-spot welding device of FIG. 1;

FIG. 3 shows a perspective view of a single-spot welding device; and

FIG. 4 a side view of the single-spot welding device of FIG. 3.

### DETAILED DESCRIPTION

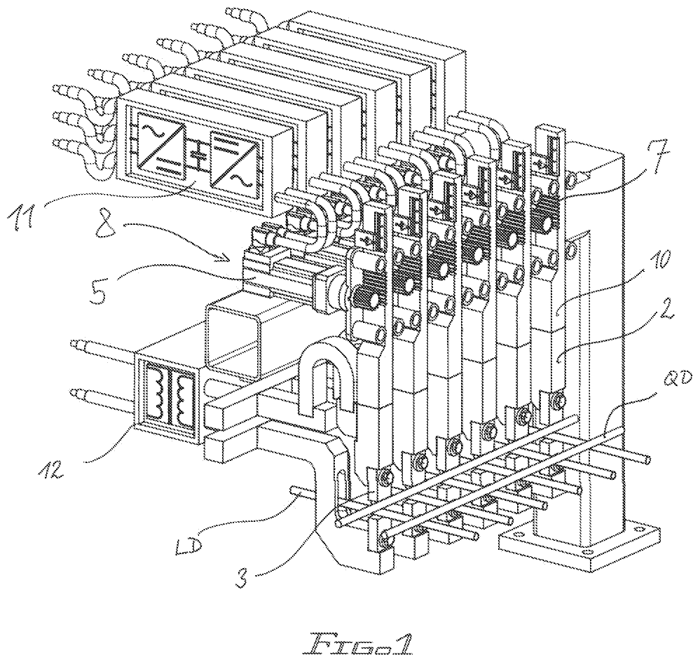

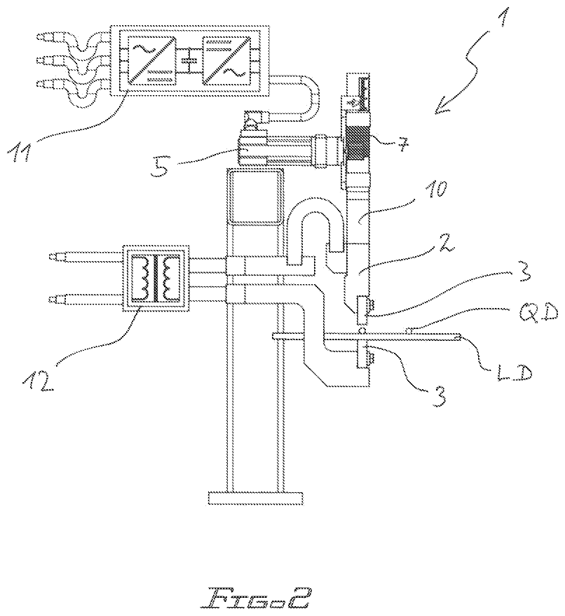

According to FIG. 1 and FIG. 2, upper welding electrodes 3 of each single-spot welding device 1 raise and lower cyclically onto the cross points of inserted longitudinal wires LD and transverse wires QD as welding material to perform the respective welds. The welding electrodes 3 are connected to a drive 8, such as a servomotor 5, via welding plungers 2 and a damping element 10. In practical use, between 20 and 100 individual spot welding devices 1 can be used side by side.

The drive 8 is operated via a frequency converter 11 and converts the rotary motion of the motor into a linear motion by means of a toothed rack 7. An electronic control operates the drive 8 and monitors the position of the welding plunger 2. The lower welding electrodes 3 can remain fixed.

The welding electrodes 3 are driven as usual by a step-down transformer 12. Electrical insulation is connected between the welding electrodes 3 and the drive 8.

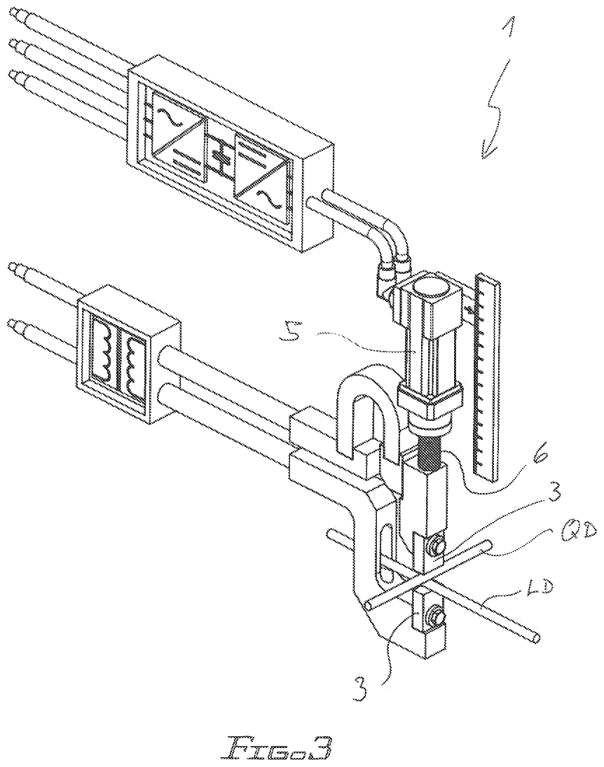

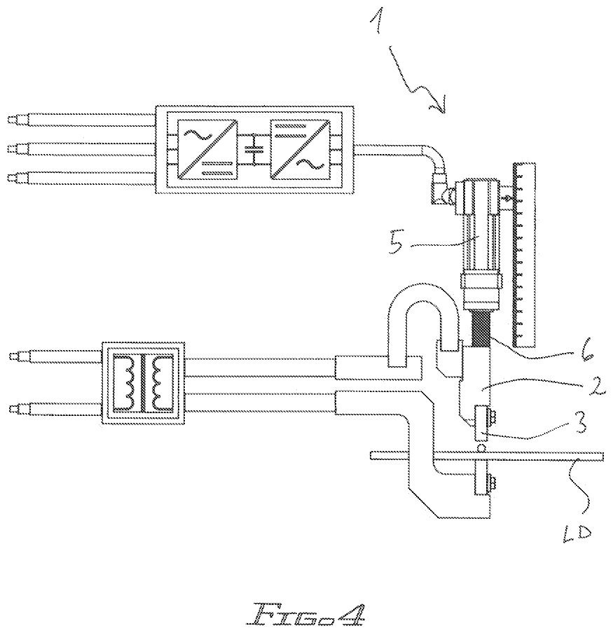

According to FIGS. 3 and 4, drive 8 can be designed as a servomotor 5 that moves the welding plunger 2 via a spindle 6.

The electrical power application according to the invention can be performed, for example, in the following three alternatives:
directly via a linear motor (not shown) with position feedback,
via a servomotor with linear unit 5 (e.g. spindle 6, FIGS. 3 and 4, or rack 7, FIGS. 1 and 2) and position feedback,
by means of a standard motor (e.g. standard servomotor) with power transmission (e.g. cam) to a spring plunger (not shown).

Criteria for use and advantages of the single-spot welding device 1:
smooth, galvanized and ribbed wires with different diameters can be welded, in particular also in combinations in which the contact point of the welding electrodes and the end point of a weld are not known;
dynamics: standard cycle times for a plunger stroke of approx. 40 milliseconds can be achieved;
Impact impulse: damping elements between drive 8 and current-carrying part are provided or an extreme reduction of speed and moving mass;
a high protection class (against metal dust and water) of the electrical components can be achieved;
a rapid increase in welding force in the welding process is necessary and achievable by enlarging the welding lens;
a service life of at least 100 million welding strokes without maintenance is achievable.

Thus, an electric welding force application element for use in welding of reinforcement elements (preferably reinforcement meshes made of longitudinal wires LD and transverse wires QD), consisting of a frequency converter 11, an electric servomotor 5 with position feedback (e.g. resolver), a mechanical gear for converting a rotation into a linear motion and an electrical insulation to the current-carrying element, is implemented. A resolver or another embodiment of fast and accurate position feedback is also provided for linear motors as drive 8.

The welding force can be adjusted as follows. The plunger stroke is selected so that the end of the movement is the sum of the longitudinal and transverse wire diameters minus the weld penetration depth, wherein the end cannot be reached; the approach to the transverse wire QD takes place at maximum speed, wherein the end position that cannot be reached is approached at reduced speed; since the welding plunger 2 cannot reach the end position, a tracking error occurs in the control program (nominal/actual comparison not possible); the torque for traversing to the nominal position is set so that this corresponds to the welding force (the theoretical end position is not reached even during welding).

This type of control can also be used to detect welding electrode wear, as there is no increased torque requirement at theoretical impact point.

In addition, the starting or end point of a weld is not known for ribbed wire. The torque of the drive 8 is set at theoretical contact with the ribbed wire, i.e. the calculated value from the wire diameters, so that it corresponds to the welding force. If there is no feedback from the drive system to the control system that it requires a set torque, welding does not yet take place. This can be the case not only with ribbed wire but also, for example, in case of electrode wear. Only when the feedback about the required torque for reaching the theoretical end point is received, the welding is initiated. Welding is then carried out for a predefined duration (in the order of milliseconds).

In this process, the movable electrodes 3 are readjusted during welding, which may be in the order of millimeters and is executed with an accuracy of at least tenths of a millimeter.

During welding, the motor torque and thus the welding force can still be increased, as the area to be welded increases due to melting. The system is assumed to be rigid—unlike welding tongs on prior art robots.

Unlike prior hydraulic and pneumatic systems, there is no need to wait for the slowest welding force application unit to start the weld, which would be dependent on pressure distribution, individual friction conditions and other factors. The electromechanical system according to the invention, consisting of a series of parallel-operating individual spot welding devices 1, operates more stably and uniformly, which shortens the waiting time and thus enables shorter cycle times.

The dynamics of the servo motor 5 are such that a ramp-up of the servo motor 5 to 2000 rpm with nominal torque under 40 milliseconds is ensured in order to achieve high cycle rates.

The ratio of external mass to motor mass is less than 1 in order to achieve very good controllability. The external mass is composed of all the parts of the single-spot welding device 1, which are moved in a cycle, with the exception of the drive 8. The motor mass is actually only the motor within the drive 8. The mass ratio achieved allows the drive element to follow more closely the preset value of the control system (nominal value). This in turn allows the welding plunger 2 to be positioned very quickly.

Position adjustment of the welding plunger 2 is performed by the control system at a high frequency to enable accurate monitoring and control of the welds.

The electric welding force application system can advantageously be designed in protection class IP 54 (industrial standard).

Since the welding plunger 2 cannot reach the end position, an intentional tracking error occurs in the control program (nominal/actual value comparison not possible).

The torque for moving to the nominal position is set so that it corresponds to the welding force (even during welding, the theoretical end position is not reached).

Since in this type of control the path and force transmission during welding are known, a new type of weld node quality control can be performed. The values determined in each case are compared with pre-computed values and any quality shortfalls are identified and reported during mat production.

The damping element 10 between the drive 8 and the welding head serves to protect the drive 8 when the welding head strikes the weld material. This is provided because experiments have shown that electric drives 8 are sensitive to impact loads of the magnitude and frequency as in the present technical context. Alternatively or in addition to the damping element 10, the welding electrode 3 can be braked by a motor in a precise position before it is applied onto the weld material.

Wire mesh mats produced with single-spot welding devices 1 according to the invention or with the method according to the invention are not only faster to produce; they also have weld spots of a higher quality than previous wire mesh mats. In addition, the quality of the spot welds is more consistent.

### LIST OF REFERENCE NUMERALS

1 Single-spot welding device
2 Welding plunger
3 Welding electrode
5 Servo motor
6 Spindle
7 Rack
8 Drive
10 Damping element
11 Frequency converter
12 Step-down transformer
LD Longitudinal wires
QD Transverse wires

What is claimed is:

1-16. (canceled)

17. A single-spot welding device having a welding plunger, wherein the welding plunger has a welding electrode and wherein the welding plunger can be moved cyclically from a starting position to a welding material, wherein an electric drive is provided, by means of which the welding plunger can be moved to the welding material and by means of which a force can be applied to the welding material.

18. The single-spot welding device of claim 17, wherein the electric drive is a linear motor.

19. The single-spot welding device of claim 17, wherein the electric drive is a servo motor connected to the welding plunger by means of a spindle or a rack, to perform the movement of the welding plunger.

20. The single-spot welding device of claim 17, wherein it has a means for position feedback in order to cyclically move the welding plunger to an initial and nominal position.

21. The single-spot welding device of claim 17, wherein the electric drive is a servo motor which is connected to the welding plunger by means of a cam, the welding plunger being designed as a spring plunger.

22. The single-spot welding device of claim 17, wherein a mechanical damping element is provided between the electric drive and the current-carrying part of the single-spot welding device.

23. The single-spot welding device of claim 17, wherein the ratio of external mass to motor mass is less than 1.

24. A wire mesh welding system with at least one single-spot welding device of claim 17.

25. A method for performing a welding comprising the following steps:
approaching a welding plunger of a single-spot welding device from a starting position to a welding material by means of an electric drive;
pressing the welding plunger onto the welding material before and/or during welding with the aid of an electric drive; and
returning the welding plunger to the starting position.

26. The method for performing a welding of claim 25, comprising the further step:
increasing the welding force during welding by applying force to the welding plunger with the aid of the electric drive.

27. The method for performing a welding of claim 25, wherein the step of approaching the welding plunger takes place in the sub-steps:
approaching the welding plunger in the direction of the welding material at a maximum speed;
approaching an end position of the welding plunger at reduced speed; and
stopping the approach to the end position before the end position is reached.

28. The method for performing a welding of claim 25, wherein an electric control is provided which controls the electric drive and monitors the positions of the welding plunger.

29. The method for performing a welding of claim 28, wherein the following two steps are provided:
comparing the nominal and actual values of the position of the welding plunger; and
calculating a wear from the nominal and actual values.

30. The method for performing a welding of claim 28, wherein the following step is provided:
calculating a wear of at least one of the welding plungers by reading the torque characteristic or the welding force characteristic.

31. The method for performing a welding of claim 28, wherein the following step is provided:
calculating the quality of weld nodes based on the movement data of the welding plungers in comparison with pre-calculated values.

32. A wire mesh made of longitudinal and transverse wires welded together, the welding spots being produced by electrically driven welding plungers of a single-spot welding device of claim 17.
